(19) United States
(12) Patent Application Publication
(10) Pub. No.: US 2004/0264899 A1
(43) Pub. Date: Dec. 30, 2004

(54) Flat plastic optical fiber and illumination apparatus using such fiber

(76) Inventors: James F. Peterson II, State College, PA (US); Pierluigi Cappellini, Jersey Shore, PA (US); Hassan Bodaghi, Alpharetta, GA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/866,465

(22) Filed: Jun. 9, 2004

Related U.S. Application Data
(63) Continuation-in-part of application No. 10/461,122, filed on Jun. 13, 2003.

(51) Int. Cl. B29D 11/00; G02B 6/02

(52) U.S. Cl. 385/123; 425/133.1; 264/1.29; 385/146

(57) ABSTRACT

Substantially flat plastic optical fibers with uniform core cross sections, methods and systems for making such fibers, and illumination devices incorporating such fibers are described.

### CROSS REFERENCE TO RELATED APPLICATION

This application is a continuation-in-part of U.S. application Ser. No. 10/461,122, filed Jun. 13, 2003, the disclosure of which is hereby incorporated by reference.

### FIELD OF INVENTION

The present invention relates to plastic optical fibers and apparatus using such fibers. More particularly, the present invention concerns substantially flat plastic optical fibers, methods and systems for making such fibers, and illumination devices incorporating such fibers.

### BACKGROUND

Plastic optical fiber (POF) has been developed for a variety of applications, including communication networks and illumination devices.

For communication networks, POF is used as a transmission medium in short-distance, high-speed networks. For this application, considerable effort has been devoted to reducing transmission losses in POF with circular cross sections. These losses can be caused by both intrinsic and extrinsic factors. Intrinsic loss factors include absorption by C-H vibrations and Rayleigh scattering. Extrinsic loss factors include absorption by transition metals and organic contaminants, as well as scattering by dust and microvoids, fluctuations in the cross section of the POF core, orientational birefringence, and core-cladding boundary imperfections.

For illumination devices, POF can be used for either “end lighting” or “side lighting.” For end lighting, the main function of the POF is to transmit light from a source to a remote point and emit the light out the end of the POF. For side lighting, the main function of the POF is to transmit light from a source out one or more sides of the POF at one or more locations along the length of the POF in a controlled manner.

POF with circular cross section is often used in illumination devices, too. For example, circular POFs can be placed side-by-side to create side-lighting strips or panels. The fabrication of such strips, however, is relatively cumbersome, expensive, and inefficient. Thus, it can be advantageous to make POF with rectangular or other substantially flat cross sections for side-lighting illumination devices. Substantially flat POF is also useful for some data communications applications, too.

Several methods have been developed to control where and how much light is transmitted out the side(s) of the POF, including abrading, etching, embossing, notching, and sharply bending the POF. With some types of control, the light that comes out of the side of a POF can be patterned into particular shapes, such as a letters, numbers, logos, or other symbols. With other types of control, the light that comes out of the side(s) of a POF produces uniform illumination.

To date, uncontrolled transmission losses in side-lighting illumination devices have been ignored because of the short lengths of POF that are typically involved. Nevertheless, to conserve energy and increase brightness, it is desirable to make these illumination devices more efficient. Uncontrolled transmission losses should be minimized in regions of the POF where no light transmission out the side of the POF is desired. Uncontrolled losses in such regions are reduced if the thickness (for flat POF) or diameter (for circular POF) of the POF core in these regions is more uniform. Conversely, light transmission out the side of the POF at one or more locations is better controlled if the thickness or diameter of the POF in these locations is more uniform prior to treating these locations (e.g., by abrading, etching, notching or other treatment that introduces a controlled light leak). Thus, there is a need to reduce loss factors in substantially flat POF for side-lighting applications. There is also a need to reduce loss factors in substantially flat POF for communications applications.

Lighting efficiency is particularly important in battery-powered illumination devices, such as displays and backlights for portable electronic equipment (e.g., laptop computers, cell phones, and personal digital assistants). In addition, given the space and weight constraints in portable electronic devices, there is also a need to make substantially flat POF with more uniform thickness at small thicknesses.

One processing variable that has not been recognized or controlled in the prior art is the direction in which the POF core is extruded. To our knowledge, all previous POF processing methods have extruded (i.e., formed or shaped by forcing through an opening) the POF core either vertically downward (i.e., with the force of gravity) or horizontally. Surprisingly, we have discovered that extruding POF vertically upward (i.e., against the force of gravity) enables POF with much less fluctuation in core cross section to be produced.

This improvement in core cross section uniformity for POF is even more surprising in view of U.S. Pat. No.4,399,084, which uses “upward spinning” to produce a “fibrous assembly” for textile applications. As noted at column 16, lines 20-24, this patent describes using vertically upward extrusion to create nonuniform, irregular textile fibers:

“A further feature of this invention is that the filament has a non-circular cross section irregularly varying in size at irregular intervals along its longitudinal direction, and incident to this, the shape of its cross section also varies.”

Thus, the prior use of vertically upward extrusion to make irregular textile fibers does not teach or suggest the use of vertically upward extrusion to make uniform POF cores.

### SUMMARY OF THE INVENTION

The present invention overcomes the limitations and disadvantages of the prior art by providing substantially flat POFs with uniform core cross sections, methods and systems for making such fibers, and illumination devices incorporating such fibers.

One aspect of the invention involves a POF with a substantially flat core with a uniform cross section. The POF also has cladding around the core.

Another aspect of the invention involves a method for making a POF in which a first polymeric starting material is melted in a first extruder and a second polymeric starting material is melted in a second extruder. The first melted polymeric starting material is extruded to form a substantially flat POF core with a uniform cross section. The second melted polymeric starting material is co-extruded to form a POF cladding around the POF core.

Another aspect of the invention involves a system that includes two extruders and an extrusion block. One extruder melts a first polymeric starting material and the other extruder melts a second polymeric starting material. The extrusion block extrudes the first melted polymeric starting material to form a substantially flat plastic optical fiber core with a uniform cross section and co-extrudes the second melted polymeric starting material to form a plastic optical fiber cladding around the plastic optical fiber core.

Another aspect of the invention involves an illumination apparatus with a light source connected optically to a POF. The POF has a substantially flat core with a uniform cross section. The POF also has cladding around the core. One or more locations along the length of the POF have been treated to permit light to come out at these locations in a controlled manner.

Another aspect of the invention involves a method for making an illumination apparatus by treating the surface of a substantially flat POF and connecting optically a light source to the POF. The surface treatment permits light to come out one or more sides of the POF at one or more locations along the length of the POF in a controlled manner. Prior to treatment, the POF has a substantially flat core with a uniform cross section. The POF also has cladding around the core.

In some embodiments, the POF is formed by continuous screw co-extrusion.

In some embodiments, the uniform cross section is such that the standard deviation in core cross section thickness is less than 5.0 percent of the average POF core cross section thickness. In some embodiments, the uniform cross section is such that the standard deviation in core cross section thickness is less than 1.0 percent of the average POF core cross section thickness. In some embodiments, the uniform cross section is such that the standard deviation in core cross section thickness is less than 0.5 percent of the average POF core cross section thickness.

In some embodiments, the POF core is formed by extrusion in a substantially vertical upward direction.

To make the POF substantially flat, the uniform core can have, without limitation, a rectangular cross section, a rectangular cross section with rounded corners, or a racetrack oval cross section with two opposing flat sides and two opposing rounded sides.

The foregoing and other embodiments and aspects of the present invention will become apparent to those skilled in the art in view of the subsequent detailed description of the invention taken together with the appended claims and the accompanying figures.

### DESCRIPTION OF DRAWINGS

FIG. 1 is a schematic diagram illustrating an exemplary system for continuously producing POF with substantially flat core cross section.

FIG. 2 is a schematic diagram illustrating the system of FIG. 1 with additional components for measuring POF uniformity, cooling POF in a controlled manner, and winding POF onto a spool.

FIG. 3 is a schematic diagram illustrating the spin pack assembly in more detail.

FIG. 4 is a schematic diagram illustrating multi-purpose blocks 350 A & 350 B and cutaway views of transfer/heating blocks 400 A & 400 B in more detail.

FIG. 5 is a flow chart illustrating an exemplary process for continuously producing substantially flat POF with uniform core cross section.

FIG. 6 is a schematic diagram illustrating exemplary core cross sections for substantially flat POF, including (a) a rectangle, (b) a rectangle with rounded corners, and (c) a racetrack oval with two opposing flat sides and two opposing rounded sides.

FIG. 7 is a flow chart illustrating an exemplary process for making an illumination device that includes a substantially flat POF with uniform core cross section.

### DETAILED DESCRIPTION

This section describes substantially flat POFs with uniform core cross sections, methods and systems for making such fibers, and illumination devices incorporating such fibers. In the following description, numerous specific details are set forth to provide a thorough understanding of the present invention. However, it will be apparent to one of ordinary skill in the art that the invention may be practiced without these particular details.

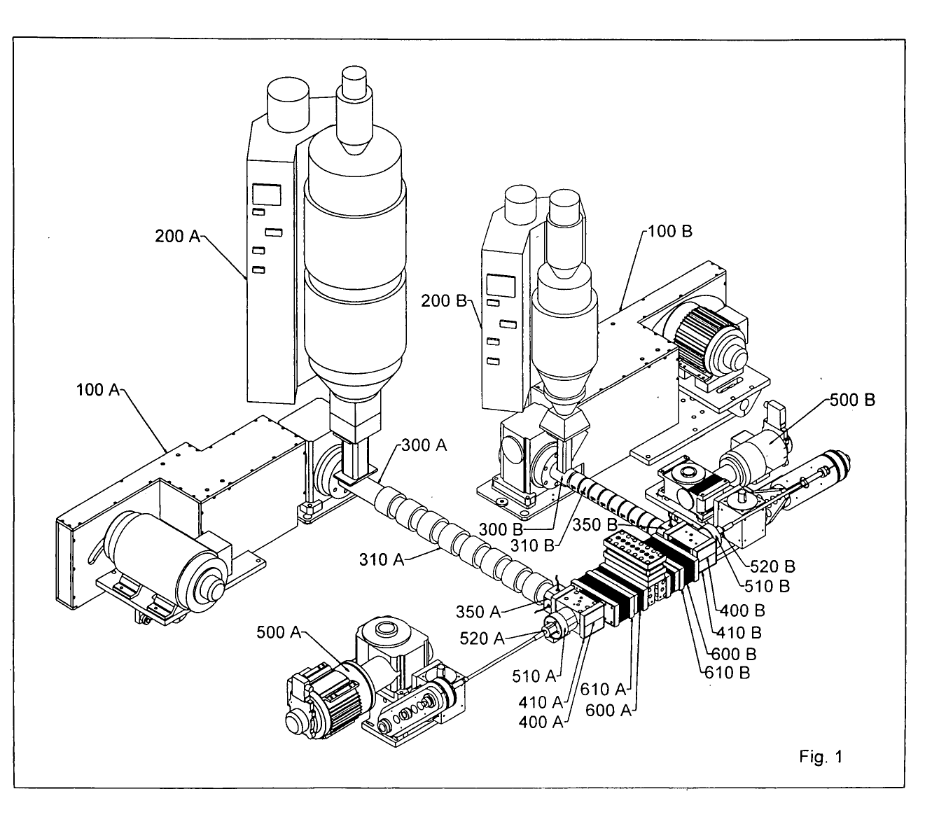

FIG. 1 illustrates an exemplary system for continuously producing POF with substantially flat core cross section. The system in FIG. 1 includes both “A” components that are used to continuously extrude the core of the POF and “B” components that are used to continuously extrude the cladding of the POF. The A and B mechanical components are nearly the same in configuration, with the main difference being the size of the motor/extruder combination. This exemplary system includes: extruder drive assemblies 100 A & 100 B, feed hopper/dryer systems 200 A & 200 B, extruder screw/barrel assemblies 300 A & 300 B, barrel heater bands 310 A & 310 B, multi-purpose blocks 350 A & 350 B, transfer/heating blocks 400 A & 400 B, band heaters 410 A & 410 B for transfer/heating blocks 400 A & 400 B, pump/drive assemblies 500 A & 500 B, pump heater bands 510 A & 510 B, planetary gear pumps 520 A & 520 B, flow distributors 600 A & 600 B, and band heaters 610 A & 610 B for flow distributors 600 A & 600 B.

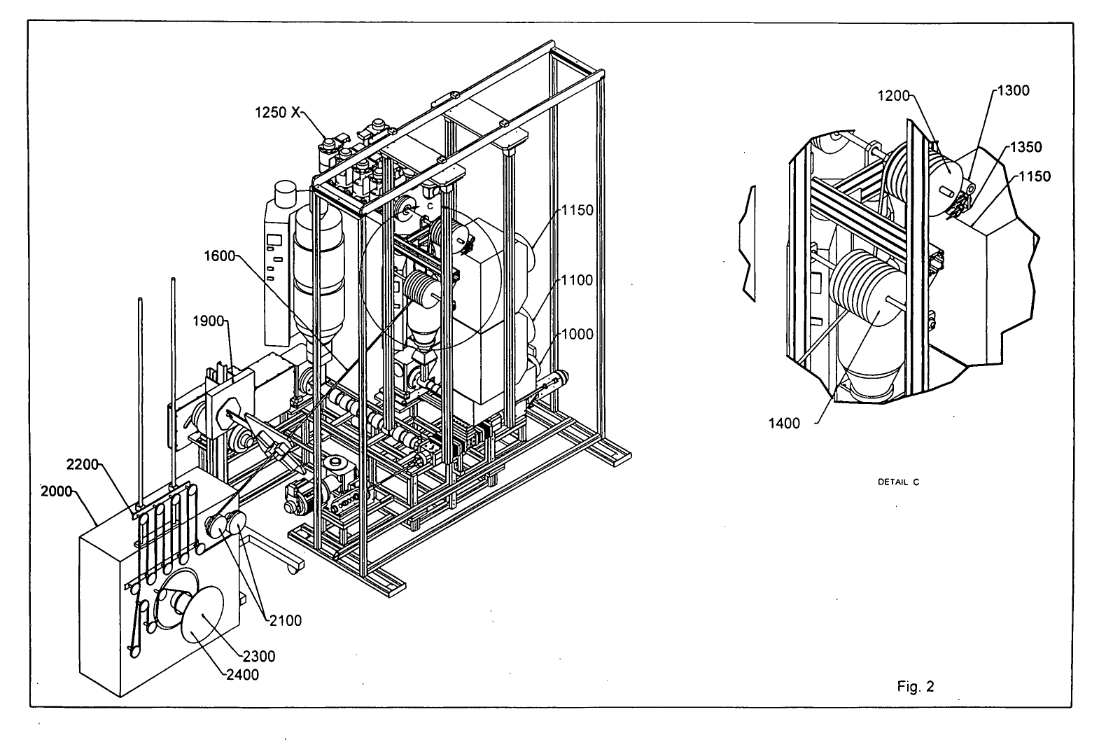

FIG. 2 illustrates the system of FIG. 1 with additional components for measuring POF uniformity, cooling POF in a controlled manner, and winding POF onto a spool. The additional components include: idler roll 1300, individual product guide 1350, segmented idler roll 1400, quench unit stage 1 1100, quench unit stage 2 1150, quench unit stage 3 1000, segmented drive roll 1200 (with independent controlling motors 1250X for each segment in drive roll 1200), laser micrometer 1900, and winding unit 2000. Winding unit 2000 includes electrically driven high precision draw rolls 2100, accumulator system 2200, and traverse mechanism 2300 for POF spool 2400.

In some embodiments, quench unit stage 3 1000 is removed and quench unit stage 1 1100 and quench unit stage 2 1150 are lowered to be closer to spinneret face plate 700. As shown in FIG. 2, in some embodiments, quench units 1000, 1100, and 1150 are stacked on top of each other in the same orientation so that the air flows in the same direction in each quench unit (e.g., right to left in FIG. 2). In other embodiments (not shown), the quench units are stacked in a staggered configuration so that the airflows are in opposite directions in adjacent quench units. For example, the airflow in quench unit stage 1 1100 is right-to-left and the airflow in quench unit stage 2 1150 is left-to-right (with quench unit stage 3 1000 removed). Opposing airflows can help keep the POF flat.

In some embodiments, each POF filament has its own winding unit 2000, which allows for individual adjustment in filament speed. (For clarity, only one winding unit 2000 is shown in FIG. 2.) Multiple winding units 2000 and multiple spinneret inserts 800 allow for the formation of distinct POF from each of the filament streams. Thus, if desired, a variety of POF with different shapes and/or sizes can be run concurrently in the extrusion system by varying the spinneret insert(s) 800 and/or the winder 2000 settings. The winding unit accumulator system 2200 provides for continuous operation of the winder even during spool changes through the accumulation of POF. The traverse mechanism 2300 controls the movement of spool 2400 and is electronically integrated to adjust take-up speed to uniformly wind POF 1600 onto the spool as the diameter of the POF accumulated on spool 2400 increases. Traverse mechanism 2300 moves POF spool 2400 in and out during POF 1600 uptake onto spool 2400. Additional adjustments are provided for each of the POF streams produced via the substitution of spinneret inserts 800, e.g., varying the spinneret size and/or geometric shape.

It will be understood by those of ordinary skill in the art that additional flow distribution channels could be connected with additional extruders to produce multilayered POF core and/or multilayered POF cladding. For example, to make graded-index POF, additional channels in spin pack assembly 950 could be connected with additional extruders 300 to produce multilayered POF core with radially varying properties (e.g., refractive index).

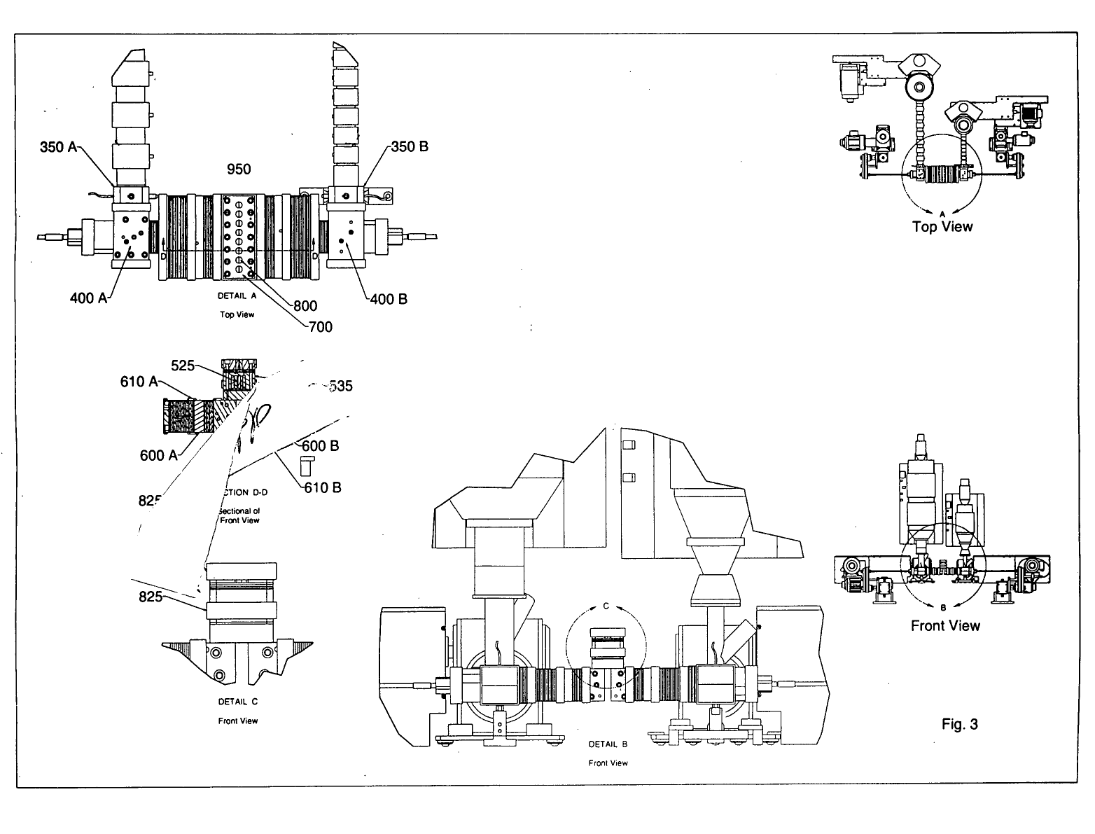

FIG. 3 illustrates spin pack assembly 950, an exemplary extrusion block that is typically comprised of a number of sub-blocks. Spin pack assembly 950 includes: multi-purpose blocks 350 A & 350 B, transfer/heating blocks 400 A & 400 B, filter block 535, flow distributors 600 A & 600 B, band heaters 610 A & 610 B for flow distributors 600 A & 600 B, spinneret face plate 700, spinneret insert(s) 800, spin face heater bands 825, and filtration/polymer integration sub-assembly 850. Filter block 535 contains polymer filters 525. Polymer filters 525 remove any polymer gels present and also remove any potential charred polymer from the extrusion system. Exemplary filter cups are available through the Mott Filter Company (84 Spring Lane, Farmington, Conn. 06032) and are capable of removing particles that typically range from 10 to 100 microns in size. Spinneret insert(s) 800 provides for rapid replacement and changeover in spinneret shape(s) and spinneret size(s). As is well-known in the art, polymer integration sub-assembly 850 combines the molten core and cladding materials just prior to co-extrusion so that (core+cladding) fiber structures can be produced (e.g., see U.S. Pat. No. 5,533,883, the disclosure of which is hereby incorporated by reference).

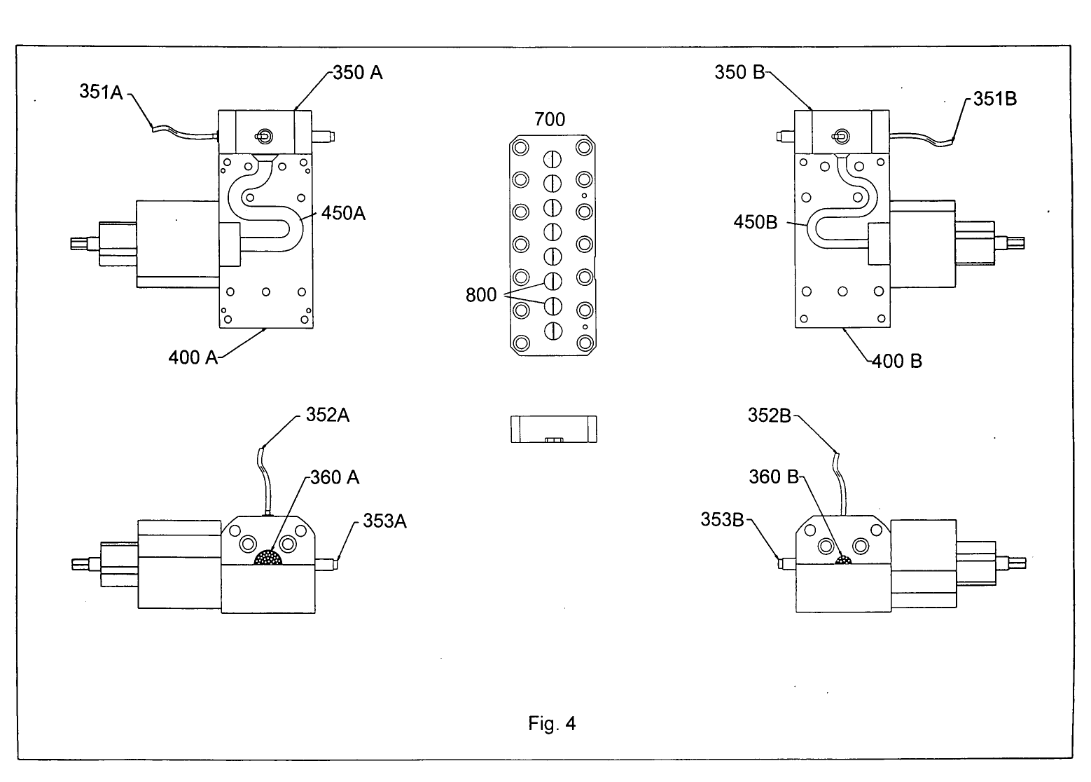

FIG. 4 illustrates multi-purpose blocks 350 A & 350 B and cutaway views of transfer/heating blocks 400 A & 400 B in more detail. Multi-purpose blocks 350 A & 350 B include burst plugs 353 A & 353 B (pressure safety valves), temperature probes 352 A & 352 B, and pressure transducers 351 A & 351 B. The design of blocks 350 A & 350 B and 400 A & 400 B minimizes resistance to polymer flow and provides feedback on processing parameters (e.g., temperature and pressure). Blocks 400 A & 400 B can be split into two halves for easier cleaning. Transfer blocks 400 A & 400 B also include breaker plates 360 A & 360 B to improve the mixing of melted polymer. FIG. 4 illustrates system components for both the core and the cladding, with each designated by an A or B, respectively. As noted above, it will be understood by those skilled in the art that spin pack assembly 950 could be connected with additional extruders to produce multilayered POF core and/or multilayered POF cladding. For example, to make graded-index POF, the system can be connected with additional extruders to produce multilayered POF core with radially varying properties (e.g., refractive index). In addition, spin pack assembly 950 could be connected with additional extruders to produce a POF with one or more jacketing layers surrounding the POF cladding. A wide variety of materials could be used as jacketing layers including, without limitation, polyethylene, polyvinylchloride, chlorinated polyethylene, nylon, polyethylene+nylon, polyethylene+fluoropolymer, polyethylene+polyvinylchloride, polypropylene, or polyethylene.

The methods described herein can be applied to virtually all POF core and cladding materials.

One exemplary POF core material is poly methyl methacrylate (PMMA). ATOFINA Chemicals, Inc. (900 First Avenue, King of Prussia, Pa. 19406) makes a PMMA resin designated “V825NA” that is a preferred core starting material because it has a high refractive index (1.49) and exhibits small transmission loss in the visible light region. Resins with higher melt flow rates, such as ATOFINA resin VID-100, may also be used.

Other exemplary POF core materials include polystyrene, polycarbonate, copolymers of polyester and polycarbonate, and other amorphous polymers. In addition, semi-crystalline polyolefins, such as cyclic olefin copolymers, high molecular weight polypropylene and high-density, high molecular weight polyethylene can be used.

Exemplary POF cladding materials include fluorinated polymers such as polyvinylidene fluoride, polytetrafluoethylene hexafluoro propylene vinylidene fluoride, and other fluoroalkyl methacrylate monomer based resins. The cladding material must have a refractive index lower than that of the core polymer. Dyneon LLC (6744 33^{rd} Street North, Oakdale, Minn. 55128) fluorothermoplastics THV220G, THV220A, THV 610G, and THV815G and ATOFINA KYNAR Superflex 2500® have refractive indices between 1.35 and 1.41, which are lower than the refractive index of ATOFINA resin V825NA.

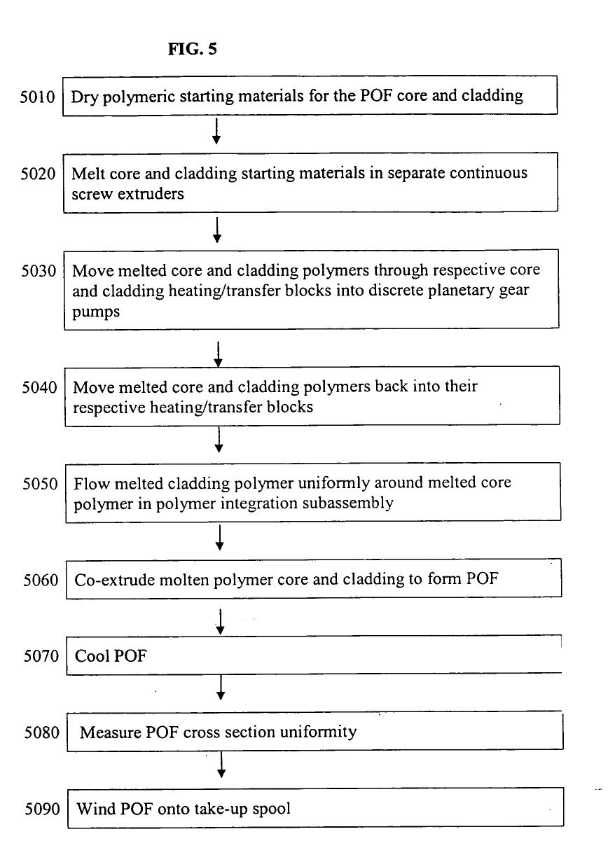

FIG. 5 is a flow chart illustrating an exemplary process for continuously producing substantially flat POF with uniform core cross section. As noted above, the core and cladding extruders operate in an analogous manner, although they may be different in size.

At 5010, pellets of clean and purified POF core and cladding polymer resins (polymeric starting materials, typically supplied by commercial resin manufacturers) are fed into feed hopper/dryer systems 200 A & 200 B, respectively. Dryer systems 200 A & 200 B continually dry the polymer resins using compressed air and a heating system. The temperature used in dryer systems 200 A & 200 B is typically between 80 and 100° C., with 90° C. being preferred. Moisture is removed from the resins by operating dryer systems 200 A & 200 B at a dew point of −40° C. Both dryer systems 200 A & 200 B also have two coalescing filters in series to remove liquid water and oil droplet particles down to 0.01 micron in size. An exemplary dryer system 200 is a Novatec™ Compressed Air Dryer (Novatec, Inc. 222 E. Thomas Ave., Baltimore Md. 21225, www.novatec.com).

At 5020, extruder drive assemblies 100 A & 100 B feed the dried polymers into extruder screw/barrel assemblies 300 A & 300 B, respectively, where the dried polymers are melted. Extruder drive assemblies 100 A & 100 B are dedicated drive systems that maintain consistent operating RPMs to provide stable pressures during the continuous extrusion processes.

The gear ratios of the pulleys in extruder drive assemblies 100 A & 100 B can be changed to enable the drive assembly motors to run at a preferred rate of 90-100% of the rated motor speed. A stable motor speed produces a stable screw speed, which, in turn, produces a consistent extrudate pressure. The measured pressure fluctuations are less than 2% during operation at various working pressures. Thus, the precision drives in extruder drive assemblies 100 A & 100 B enable greater extruder control and feeding uniformity of the extrudates.

In some embodiments, extruder screw/barrel assemblies 300 A & 300 B may be vented to remove volatile contaminants from the melted resins. In some embodiments, the polymers in the extruder assemblies may be blanketed with nitrogen (or inert gas) or subjected to vacuum in order to further reduce resin contamination and to improve the uniformity of the melts.

At 5030, the feed screws in extruder screw/barrel assemblies 300 A & 300 B move the melted core and cladding polymers through multipurpose blocks 350 A & 350 B and transfer/heating blocks 400 A & 400 B into planetary gear pumps 520 A & 520 B, respectively, in a continuous, uniform manner. Planetary gear pumps 520 A & 520 B are driven by dedicated drive assemblies 500 A & 500 B, respectively. Pumps 520 A & 520 B are single inlet pumps with multiple outlets. In some embodiments, the temperatures for the core and cladding polymers of the POF are independently controlled and only come together as the POF is being formed, thereby allowing for core and cladding polymers with different temperatures to be extruded simultaneously.

At 5040, the melted core and cladding polymers move back into their respective transfer/heating blocks 400 A & 400 B in a continuous, uniform manner. Pumps 520 A & 520 B pressurize the molten polymers as they divide and distribute the flows into independent distribution channels in transfer blocks 400 A & 400 B. For clarity, FIG. 4 shows just one of the independent channels (i.e., channel 450 A) located within transfer/heating block 400 A. Similarly, FIG. 4 shows just one of the independent channels (i.e., channel 450 B) located within transfer/heating block 400 B.

Channels 450 A and 450 B in blocks 400 A & 400 B, respectively, permit high polymer flow rates with low restriction, thereby reducing shear heating (and concurrent temperature nonuniformities) in the polymer melts. The direction of polymer flow in spin pack assembly 950 can be changed in 90° increments. Thus, extrusion via spin pack assembly 950 can be vertically upward, vertically downward, or horizontal. Heating bands 610 A & 610 B facilitate temperature control (and thus viscosity control) of the molten polymers while passing through spin pack assembly 950.

At 5050, the molten cladding material flows uniformly around the molten POF core material in polymer integration subassembly 850, just before the molten core and cladding enter spinneret face plate 700. Spinneret face plate 700 is equipped with spinneret inserts 800. Spinneret inserts 800 enable rapid changeover in spinneret hole diameter, shape and the pin length-to-diameter ratio. The spin face heaters 825 control the temperature uniformity of the core and cladding extrudates as they exit the spinneret inserts 800 to form POF 1600. For ATOFINA resin V825NA core and Dyneon LLC fluorothermoplastic THV220G cladding, the temperature of spinneret face plate 700 is typically between 250 and 270° C., with a preferred temperature of 262° C.

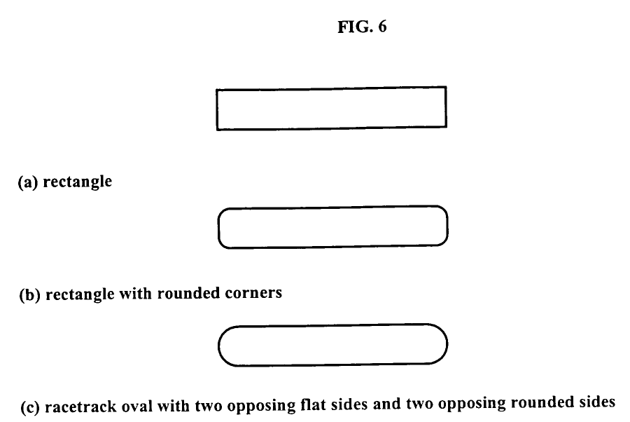

At 5060, the molten polymer core and cladding are co-extruded through spinneret face plate 700. Forcing the molten polymer core through rectangular or other similarly shaped openings in spinneret insert(s) 800 forms POF core with substantially flat cross-sections. FIG. 6 illustrates exemplary core cross sections for substantially flat POF cores, including (a) rectangular, (b) rectangular with rounded corners, and (c) racetrack oval. Co-extruding the molten polymer cladding that has flowed around the molten core material through openings in spinneret insert(s) 800 forms a cladding layer around the substantially flat POF core. Spinneret insert(s) 800 may be changed to allow simultaneous production of different size and/or shaped POF, thereby adding versatility to the production system.

In some embodiments, spinneret face plate 700 and spinneret insert(s) 800 may be replaced by a face plate with a long, narrow slit that permits a wide sheet of core material with uniform thickness to be extruded. In some embodiments, the sheet of core material can then be cut into strips (e.g., by a laser or other cutting tool). In turn, the strips can be coated with cladding material to produce substantially flat POF

In some embodiments, to increase the uniformity of the POF core cross sections, the extrusion in step 5060 is performed in a substantially vertical upward direction, against the force of gravity.

If vertically upward extrusion is used, at the start of the extrusion process, a metal rod or other inert surface makes contact with POF 1600 exiting spinneret insert 800, and lifts POF 1600 up through individual product guide 1350, then to idler roll 1300 and onto drive roll 1200. POF 1600 is/are then passed over segmented idler roll 1400 and through the rest of the system in the same manner as is commonly done for horizontal or vertically downward extrusion processes. Each segment in idler roll 1400 can spin at a different speed if POF streams with different dimensions are being extruded simultaneously. Alternatively, each segment in idler roll 1400 can spin at the same speed if POF streams with the same dimensions are being extruded simultaneously.

At 5070, POF 1600 is cooled in a controlled manner. In some embodiments, POF 1600 is cooled in a two- or three-stage cooling zone system.

In a two-stage cool with stage 3 quench unit 1000 removed, stage 1 quench unit 1100 is located adjacent to the spinneret face 700 and typically 3.5 inches away from POF 1600 exiting spinneret insert(s) 800. Stage 1 quench unit 1100 gradually cools POF 1600 by blowing air over the fibers. Stage 1 quench unit 1100 is typically operated between 0 and 30° C., with 20° C. being preferred. Fans in stage 1 quench unit 1100 typically operate between 0 and 1750 RPM (corresponding to a measured air velocity of 0-493 feet per minute), with 650 RPM (96 feet per minute) being preferred. Stage 2 quench unit 1150 typically operates at lower temperature than Stage 1 quench unit 1100, at temperatures between 0 and 30° C., with 15° C. being preferred. Fans in stage 2 quench unit 1150 typically operate between 0 and 1750 RPM (corresponding to a measured air velocity of 0-573 feet per minute), with 650 RPM (134 feet per minute) being preferred. Stage 2 quench unit 1150 is stacked in a staggered configuration with stage 1 quench unit 1100 so that the airflows in quench units 1100 and 1150 are in opposite directions. Stage 2 quench unit 1100 is positioned typically 2 inches away from the centerline of POF 1600. The staggered configuration allows for more uniform application of cool air to POF 1600, thereby producing more uniform cooling and preventing curling of the flat POF. In some embodiments, the quench system is segmented into discrete chambers around each POF filament stream to allow for individual control of air temperature and air speed around each individual POF filament stream.

In some embodiments, stage 1 1100, stage 2 1150 and stage 3 1000 quench units are stacked directly on top of one another. This embodiment is preferred for round fibers as the “curling” effect is less prevalent. This embodiment also can be segmented to allow for individual control of air temperature and airflow speed for each POF. Table 1 and Table 2 give exemplary process conditions for the co-extrusion of core/cladding that produces a substantially flat POF 1600.

TABLE 1

| | Temperature | |
|---|---|---|
| | (° C.) | Temperature (° C.) |
| Component | for Core (A) | for Cladding (B) |
| screw/barrel assembly 300 zone 1 | 190 | 160 |
| (zone nearest dryer 200) | | |
| screw/barrel assembly 300 zone 2 | 205 | 165 |
| screw/barrel assembly 300 zone 3 | 225 | 175 |
| screw/barrel assembly 300 zone 4 | 225 | 180 |
| screw/barrel assembly 300 zone 5 | 225 | 225 |
| (zone nearest block 350) | | |
| planetary gear pump 520 inlet | 231 | 220 |
| planetary gear pump 520 block | 221 | 177 |
| planetary gear pump 520 outlet | 251 | 244 |
| pump heater band 510 | 240 | 240 |
| band heater 410 | 225 | 225 |
| band heater(s) 610 | 247 | 250 |
| plate 700 inlet | 262 | 268 |
| spin face heater band 825 | 262 | 262 |

TABLE 2

| | Core (A) | Cladding (B) |
|---|---|---|
| Screw/barrel assembly 300 pressure | 1000 | 1200 |
| set point (PSI) | | |
| Planetary gear pump 520 outlet | 1242 | 1252 |
| pressure (PSI) | | |
| Planetary gear pump 520 speed | 18 | 1.55 |
| (RPM) | | |

6,500 micron wide × 500 micron thick POF was produced at 5.8 meters per minute.

At 5080, the uniformity of the POF cross section is measured. To measure the uniformity of the POF core cross section, the POF core alone can be extruded and measured (i.e., the cladding is not extruded around the POF core for these measurements). However, as shown in Table 3, the uniformity of the POF core cross section is essentially the same as the uniformity of the entire POF (core+cladding) cross section because the cladding thickness (typically 10-30 microns) is much less than the core thickness. In some embodiments, the measurement is done using laser micrometer 1900. An exemplary laser micrometer 1900 is a Beta LaserMike diameter gauge (Beta LaserMike, 8001 Technology Blvd., Dayton, Ohio 45424, www.betalasermike.com). In some embodiments, to increase the uniformity of the POF cross section, laser micrometer 1900 can be part of an on-line automatic feedback control system. An automatic feedback system integrated with laser micrometer 1900 can send information used to control a servo-motor system for each POF filament, thereby controlling size and operation independently for each POF filament.

As shown in FIG. 2, at 5090, POF 1600 is fed to S wrap system 2100 in winding unit 2000 and wound onto POF spool 2400.

In addition to the steps described above, after extrusion, POF 1600 can be drawn (i.e., stretched) by a variety of different methods, including without limitation: (1) spin drawing; (2) spin drawing plus solid-state drawing; and (3) continuous incremental drawing.

In spin drawing, POF 1600 are drawn immediately after co-extrusion and wound onto a spool. This drawing method typically provides excellent cladding uniformity with no phase separation between the cladding and POF core. This drawing method typically produces POF with low molecular orientation and moderate strength.

In spin drawing plus solid-state drawing, POF 1600 are drawn immediately after co-extrusion and wound onto a spool. POF 1600 are then unwound from the spool in a secondary process and drawn in the solid state with a large draw ratio. This drawing method typically produces highly oriented POF with high strength and excellent cladding uniformity. However, phase separation between the core and cladding during the solid-state drawing step may produce defects in POF 1600.

In continuous incremental drawing, co-extruded POF 1600 are continuously drawn by increasing the linear speed of each roll that POF 1600 passes over. For example, the linear speed of a second roll will be greater than the linear speed of a first roll, thereby drawing the POF between the second roll and the first roll. This incremental drawing process can be repeated between additional rolls and under different drawing temperatures. This drawing procedure results in a large draw ratio and high molecular orientation without a separate solid-state drawing step. This drawing method typically produces high strength POF with excellent physical and environmental stability, excellent cross section uniformity, and no phase separation between the cladding and core of POF 1600.

Substantially flat POF 1600 with a wide range of widths and thicknesses can be manufactured. Table 3 presents exemplary dimensional data for substantially flat POF with and without cladding for two nominal thickness-width combinations, namely 0.5 mm thick by 6.5 mm wide and 0.9 mm thick by 40 mm wide. The standard deviation in POF core cross section thickness is less than 1.0 percent of the average POF core cross section thickness. In some cases, the standard deviation in POF core cross section thickness is less than 0.5 percent of the average POF core cross section thickness. As noted above, the uniformity of the POF core cross section is essentially the same as the uniformity of the entire POF (core+cladding) cross section because the cladding thickness is much less than the core thickness. The data in Table 3 comes from samples that were continuously extruded in an upwards direction using ATOFINA V825NA resin for the core and Dyneon THV220G for the cladding.

TABLE 3

| Nominal POF dimensions | Actual Width | Actual Thickness |
|---|---|---|
| (microns) | (microns) | (microns) |
| 6,500 wide × 500 thick | Avg: 6,427 | Avg: 524.6 |
| (core w/cladding) | StdDev: 22.2 | StdDev: 2.5 |
| | N = 100 Samples | Max: 532.4 |
| | | Min: 518.8 |
| | | Range: 13.6 |
| | | N = 100 Samples |
| 6,500 wide × 500 thick | Avg: 6,506 | Avg: 507.7 |
| (core w/out cladding) | StdDev: 18.4 | StdDev: 2.1 |
| | N = 100 Samples | Max: 515.4 |
| | | Min: 500.9 |
| | | Range: 14.5 |
| | | N = 100 Samples |
| 40,000 wide × 900 thick | Avg: 41,341 | Avg: 946.1 |
| (core w/cladding) | StdDev: 61.7 | StdDev: 5.4 |
| | N = 117 Samples | Max: 968.7 |
| | | Min: 932.7 |
| | | Range: 36.0 |
| | | N = 116 Samples |
| 40,000 wide × 900 thick | Avg: 40,116 | Avg: 849.9 |
| (core w/out cladding) | StdDev: 74.5 | StdDev: 5.5 |
| | N = 101 Samples | Max: 863.2 |
| | | Min: 837.0 |
| | | Range: 26.2 |
| | | N = 100 Samples |

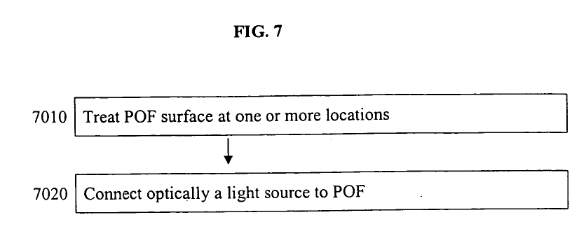

FIG. 7 is a flow chart illustrating an exemplary process for making an illumination device that includes a substantially flat POF with uniform core cross section.

At 7010, the surface of POF 1600 is treated at one or more locations along the length of POF 1600 to control where and how much light is transmitted out the side(s) of POF 1600. Exemplary surface treatments include abraiding, etching, embossing, notching, and sharply bending the POF. Examples of these methods are described in U.S. Pat. Nos. 4,756,701; 5,136,480; 5,187,765; 5,195,162; 5,312,570; 5,499,912; 6,079,838; 6,289,150; 6,361,180; and 6,416,390 and U.S. patent application 2001/No. 0050667 A1, the disclosures of which are hereby incorporated by reference.

At 7020, a light source [e.g., a light emitting diode, laser diode, vertical cavity surface emitting laser (VCSEL), or an incandescent lamp] is connected optically to POF 1600 to produce an illumination device. Examples of such connecting methods are described in U.S. Pat. Nos. 4,756,701; 5,136,480; 5,187,765; 5,195,162; 6,079,838; 6,361,180; and 6,416,390 and U.S. patent application 2001/No. 0050667 A1.

The various embodiments described above should be considered as merely illustrative of the present invention. They are not intended to be exhaustive or to limit the invention to the forms disclosed. Those skilled in the art will readily appreciate that still other variations and modifications may be practiced without departing from the general spirit of the invention set forth herein. Therefore, it is intended that the present invention be defined by the claims that follow.

What is claimed is:

1. A plastic optical fiber comprising:
a substantially flat plastic optical fiber core with a uniform cross section, and
a plastic optical fiber cladding around said plastic optical fiber core,
wherein said plastic optical fiber is formed by continuous screw co-extrusion in a substantially vertical upward direction, and
wherein said uniform cross section has a standard deviation in thickness less than 0.5 percent of the average core cross section thickness.

2. A plastic optical fiber comprising:
a substantially flat plastic optical fiber core with a uniform cross section, and
a plastic optical fiber cladding around said plastic optical fiber core.

3. The plastic optical fiber of claim 2, wherein said plastic optical fiber is formed by continuous screw co-extrusion.

4. The plastic optical fiber of claim 2, wherein said uniform cross section has a standard deviation in thickness less than 5.0 percent of the average core cross section thickness.

5. The plastic optical fiber of claim 2, wherein said uniform cross section has a standard deviation in thickness less than 1.0 percent of the average core cross section thickness.

6. The plastic optical fiber of claim 2, wherein said uniform cross section has a standard deviation in thickness less than 0.5 percent of the average core cross section thickness.

7. The plastic optical fiber of claim 2, wherein said plastic optical fiber is formed by co-extrusion in a substantially vertical upward direction.

8. The plastic optical fiber of claim 2, wherein said plastic optical fiber is a step-index plastic optical fiber.

9. The plastic optical fiber of claim 2, wherein said plastic optical fiber is a graded-index plastic optical fiber.

10. A method for making a plastic optical fiber, comprising:
melting a first polymeric starting material in a first extruder,
melting a second polymeric starting material in a second extruder,
extruding said first melted polymeric starting material to form a substantially flat plastic optical fiber core with a uniform cross section, and
co-extruding said second melted polymeric starting material to form a plastic optical fiber cladding around said plastic optical fiber core.

11. The method of claim 10, wherein said first extruder and said second extruder are continuous screw extruders.

12. The method of claim 10, wherein said uniform cross section has a standard deviation in thickness less than 5.0 percent of the average core cross section thickness.

13. The method of claim 10, wherein said uniform cross section has a standard deviation in thickness less than 1.0 percent of the average core cross section thickness.

14. The method of claim 10, wherein said uniform cross section has a standard deviation in thickness less than 0.5 percent of the average core cross section thickness.

15. The method of claim 10, wherein said extruding is performed in a substantially vertical upward direction.

16. A system for making a plastic optical fiber, comprising:
a first extruder that melts a first polymeric starting material,
a second extruder that melts a second polymeric starting material, and
an extrusion block that extrudes said first melted polymeric starting material to form a substantially flat plastic optical fiber core with a uniform cross section and co-extrudes said second melted polymeric starting material to form a plastic optical fiber cladding around said plastic optical fiber core.

17. The system of claim 16, wherein said first extruder and said second extruder are continuous screw extruders.

18. The system of claim 16, wherein said uniform cross section has a standard deviation in thickness less than 5.0 percent of the average core cross section thickness.

19. The system of claim 16, wherein said uniform cross section has a standard deviation in thickness less than 1.0 percent of the average core cross section thickness.

20. The system of claim 16, wherein said uniform cross section has a standard deviation in thickness less than 0.5 percent of the average core cross section thickness.

21. The system of claim 16, wherein said extrusion block extrudes in a substantially vertical upward direction.

22. A system for making a plastic optical fiber, comprising:
means for melting a first polymeric starting material in a first extruder,
means for melting a second polymeric starting material in a second extruder,
means for extruding said first melted polymeric starting material to form a substantially flat plastic optical fiber core with a uniform cross section, and
means for co-extruding said second melted polymeric starting material to form a plastic optical fiber cladding around said plastic optical fiber core.

23. An illumination apparatus comprising:
a light source,
a plastic optical fiber formed by co-extrusion comprising
a substantially flat plastic optical fiber core with a uniform cross section,
a plastic optical fiber cladding around said plastic optical fiber core,
and one or more locations along the length of said fiber that have been treated to permit light to come out at said locations in a controlled manner,
wherein said light source is connected optically to said plastic optical fiber.

24. The illumination apparatus of claim 23, wherein said lastic optical fiber is formed by continuous screw co-extrusion.

25. The illumination apparatus of claim 23, wherein said uniform cross section has a standard deviation in thickness less than 5.0 percent of the average core cross section thickness.

26. The illumination apparatus of claim 23, wherein said uniform cross section has a standard deviation in thickness less than 1.0 percent of the average core cross section thickness.

27. The illumination apparatus of claim 23, wherein said uniform cross section has a standard deviation in thickness less than 0.5 percent of the average core cross section thickness.

28. The illumination apparatus of claim 23, wherein said plastic optical fiber is formed by co-extrusion in a substantially vertical upward direction.

29. A method for making an illumination apparatus, comprising
treating the surface of a substantially flat plastic optical fiber with a uniform cross section to permit light to come out one or more sides of said fiber at one or more locations along the length of said fiber in a controlled manner, and
connecting optically said fiber to a light source.

30. The method of claim 29, wherein said plastic optical fiber is formed by continuous screw co-extrusion.

31. The method of claim 29, wherein said uniform cross section has a standard deviation in thickness less than 5.0 percent of the average core cross section thickness.

32. The method of claim 29, wherein said uniform cross section has a standard deviation in thickness less than 1.0 percent of the average core cross section thickness.

33. The method of claim 29, wherein said uniform cross section has a standard deviation in thickness less than 0.5 percent of the average core cross section thickness.

34. The method of claim 29, wherein said plastic optical fiber is formed by extrusion in a substantially vertical upward direction.
